(19) United States
(12) Patent Application Publication
(10) Pub. No.: US 2013/0137186 A1
(43) Pub. Date: May 30, 2013

(54) EMBOSSED SAMPLE SWAB

(71) Applicants: David J. Rutter, North Andover, MA (US); Abiy Eshetu, Arlington, MA (US)

(72) Inventors: David J. Rutter, North Andover, MA (US); Abiy Eshetu, Arlington, MA (US)

(73) Assignee: DSA DETECTION LLC, North Andover, MA (US)

(21) Appl. No.: 13/307,142

(22) Filed: Nov. 30, 2011

(51) Int. Cl. G01N 21/78; B28B 11/08; B05D 5/06; G01N 31/22

(52) U.S. Cl. 436/169; 422/420; 264/293; 427/256

(57) ABSTRACT

Embodiments of the present invention are directed to swabs and methods of formation and use of swabs for collecting trace samples from an object of interest for testing for the presence of substances. The swabs have working areas and border portions and one or more features providing an indication of the working areas.

### BACKGROUND OF INVENTION

Aspects and embodiments of the present invention are related to apparatus and methods for swabs and for facilitating the collection and analysis of trace samples of material for testing for the presence of contraband such as illicit drugs and/or explosives.

### SUMMARY OF INVENTION

Aspects and embodiments of the present invention relate to swabs and facilitate the collection of trace chemical samples from objects and for testing of the collected samples for the presence of substances such as explosives and/or illicit drugs. The samples may be in the form of solids, liquids, or gasses. The collection of the samples may involve contacting a sample collection apparatus with the surface of a suspect object to transfer trace chemical samples onto a sample collection medium. Samples may additionally or alternatively be collected by applying a vacuum to a surface of a sample collection medium which may draw air including vapors or suspended particles from the suspect object into the sample collection medium where they become trapped. A sample collection medium may alternatively be referred to as a “sample swab,” a “sample trap,” a “swab,” or a “trap,” and these terms are used interchangeably herein.

In accordance with an aspect of the present invention there is provided a swab for the collection and/or analysis of materials for the presence of a substance. The swab comprises a substrate including a working area. The working area is configured to collect material. The swab further comprises a marking indicating a portion of the working area.

In accordance with some embodiments, the marking provides a visual indication of the location of the working area.

In accordance with some embodiments, the marking provides a tactile indication of the location of the working area.

In accordance with some embodiments, the marking comprises an embossment in the substrate.

In accordance with some embodiments, the marking comprises a colored area of the substrate.

In accordance with some embodiments, the marking comprises a stitching in the substrate.

In accordance with some embodiments, the swab further comprises a marking indicating a proper position of the swab within a sample analysis system.

In accordance with another aspect of the present invention, there is provided a method for testing an article for the presence of a substance. The method comprises providing a swab having an indicated working area, the indication of the working area facilitating the placement of the swab in a sample collection apparatus.

In accordance with some embodiments, the indication of the working area facilitates the placement of the swab in a sample collection apparatus such that the working area is substantially centered in a sample collection area of the sample collection apparatus.

In accordance with some embodiments, providing the swab comprises visually indicating the working area.

In accordance with some embodiments, providing the swab comprises providing a tactile indication of the working area.

In accordance with some embodiments, providing the swab comprises indicating the working area by embossing a portion of the swab.

In accordance with some embodiments, visually indicating the working area comprises coloring a portion of the swab.

In accordance with some embodiments, visually indicating the working area comprises providing a stitching in a portion of the swab.

In accordance with some embodiments, providing the swab further comprises forming a marking in the swab indicating a position of the swab within a sample analysis system.

In accordance with another aspect of the present invention, there is provided a method of forming a swab. The method comprises providing a substrate, defining a working area on the substrate, and indicating a portion of the working area on the substrate.

In accordance with some embodiments, indicating the portion of the working area comprises embossing a portion of the substrate. Embossing a portion of the swab may comprise embossing the working area.

In accordance with some embodiments, indicating the portion of the working area comprises coloring a portion of the substrate.

In accordance with some embodiments, indicating the portion of the working area comprises including stitching having a different color than the substrate in a portion of the substrate.

In accordance with some embodiments, the method further comprises forming an indicator on the swab which facilitates the positioning of the swab in a sample analysis system.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a plan view of an embodiment of a swab;

FIG. 2 is a plan view of another embodiment of a swab;

FIG. 3 is a plan view of another embodiment of a swab;

FIG. 4 is a plan view of another embodiment of a swab;

FIG. 5 is a plan view of another embodiment of a swab;

FIG. 6 is a plan view of another embodiment of a swab;

FIG. 7 is a plan view of another embodiment of a swab;

FIG. 8 is a plan view of another embodiment of a swab;

FIG. 9 is a plan view of another embodiment of a swab;

FIG. 10 is an elevational view from the side of another embodiment of a swab;

FIG. 11 is a plan view of another embodiment of a swab;

FIG. 12 is a plan view of another embodiment of a swab;

FIG. 13 is a plan view of another embodiment of a swab;

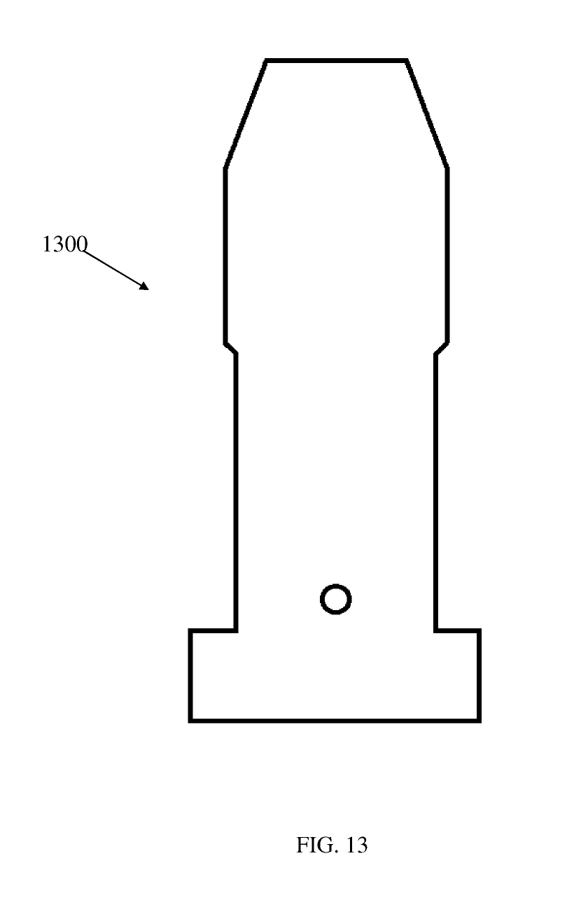

FIG. 14 is a perspective view of another embodiment of a swab; and

FIG. 15 is a plan view of another embodiment of a swab.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

The collection of trace samples from objects for testing for the presence of contraband such as explosives or illicit drugs has become a concern in recent years, especially in environments such as airports or other transportation hubs. It is believed that the testing of suspect packages or other objects for the presence of contraband may serve to deter the trafficking of drugs and/or explosives for nefarious purposes such as criminal activities or terrorism.

A method for testing for the presence of contraband involves the collection of particles and/or liquid samples from a surface of a suspect object and/or of vapors emanating from a suspect object on a sampling medium and analyzing the collected particulate, liquid, and/or vapor sample for the presence of contraband materials. In some methods, test samples are collected on swabs. Swabs may be formed from a sheet of substrate material. The substrate material may be, for example, paper, a fabric such as cotton or polyester, a polymer such as polyimide, polyamide, or polytetrafluoroethylene, or in some examples, a screen or mesh of fiberglass or of a metal such as stainless steel. In some methods, a sample is transferred from a surface of an object of interest onto a swab by wiping the swab over a portion of the surface of the object. In other methods, a vapor emanating from an object of interest, and/or air that is blown across a surface of the object is directed onto a test swap where particulates and/or vapors may be trapped. In some methods a vacuum generator is utilized to pull gas containing vapors and/or suspended particulates from the object of interest into the swab. In instances where it is desired to collect samples by passing potentially contaminated air through the swab, the swab may be sufficiently porous to provide for passage of air through the swab yet sufficiently thick to collect a desired amount of sample material to test. In some instances, swabs are impregnated with one or more materials, for example, activated carbon, which may enhance the ability of the swab to collect materials of interest.

Once a sample has been collected on a swab, the swab may be transferred into an analysis/detection system to check for the presence of contraband. Appropriate test systems may include, for example, mass spectrometers, fourier transform infrared spectrometers, ion trap mobility spectrometers, ion mobility spectrometers, and other systems known in the art for the analysis and identification of trace samples of materials. In some instances, the testing system may heat the swab to vaporize contraband particles and/or liquids which may be present and analysis is performed upon the vapor. One example of such an analysis system is disclosed in U.S. Pat. No. 5,491,337 to Jenkins et al.

In other methods, a chemical solution which reacts by, for example, changing color in the presence of a particular compound of interest may be utilized to test for the presence of that compound on a swab. The chemical solution may be added to a swab prior to sampling an object with the swab, or may be applied to a swab after a sample has been collected on the swab.

For collecting a sample, a swab may be mounted on a hand held testing wand to facilitate sampling of a suspect object by an operator. Testing wands may expose a portion of a swab for contact with a suspect object while retaining the swab by securing another portion of the swab to a portion of the testing wand. Some embodiments of testing wands may include a vacuum system configured to draw vapor through the swab. Examples of hand held testing wands are described in, for example, U.S. Pat. Nos. 5,859,375 and 6,446,514 to Danylewych-May et al. In other methods, a swab may be wiped across a surface of an object of interest by hand without the use of a testing wand.

Swabs may include one or more areas where it is desired to collect a sample, part or all of which may be a working area, and one or more areas that are used to handle the swab. The working area of a swab may be substantially surrounded by a border portion. The border portion may be sufficiently large that the swab may be easily handled without contacting the working portion. It may desirable to avoid contacting the working portion with objects other than the object(s) to be tested to avoid potential cross-contamination of any samples collected.

It may be desirable to collect a sample to be tested on the working area of the swab so that an operator may know which portion of the swab should be tested for the presence of a compound of interest.

To obtain accurate testing results, it may be desirable to properly align the working area of a swab in an appropriate position within an analysis/detection system. If the working area is not placed in a proper position in the analysis/detection system, a smaller than desired amount of the working area may be analyzed and/or analysis may be performed on part of the border portion of the swab. Improper alignment of the swab in the analysis/detection system may result in a false negative result if a contaminated working area is not placed in a proper position for analysis. A false positive result may be obtained if a cross-contaminated border portion of a swab is analyzed due to improper positioning of the swab in the analysis/detection system.

To facilitate handling of a swab while avoiding unintended contact with the working area, to facilitate collecting a sample in a known area of a swab, and to facilitate proper positioning of a swab in an analysis/detection system, it has been found useful to identify the portion of a swab corresponding to the working area. This identification may be performed in numerous ways as shown in the exemplary embodiments illustrated in the figures.

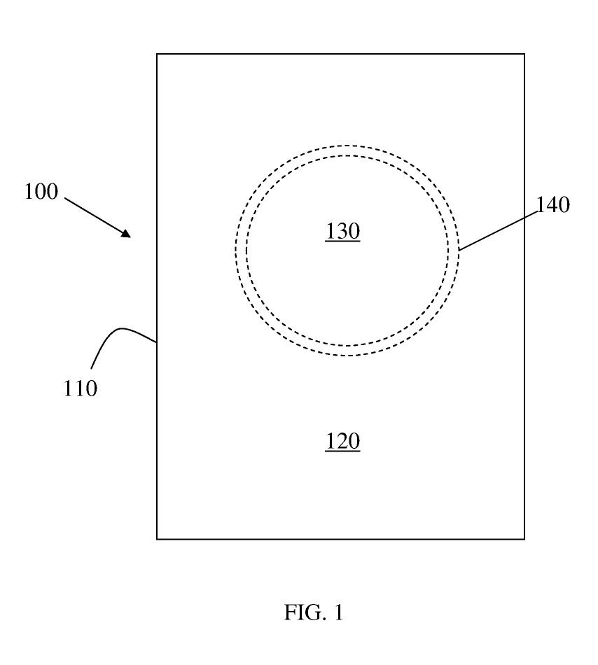

In one embodiment, illustrated in FIG. 1, a swab 100 includes a substrate 110 with a border portion 120 and a working area 130. The working area 130 is surrounded by a circle 140 embossed in the substrate. The embossed circle 140 indicates the boundary between the working area 130 and the border portion 120 of the swab 100. The embossed circle 140 may be visible to an operator and may indicate to the operator which portions of the swab 100, for example, the portions outside of the embossed circle, may be handled and which portions, for example, portions within the embossed circle, should not. The embossed circle 140 may also provide an indication to the operator which area of the swab should be used to collect a sample and/or aligned with an appropriate area of an analysis/detection system so that the swab may be properly analyzed. The embossed circle 140 may additionally or alternatively provide a tactile indication of the location of the working portion of the swab. In some embodiments, a “buffer zone” of substrate (not shown) may be provided between the internal edge of the embossment and a boundary of the working area.

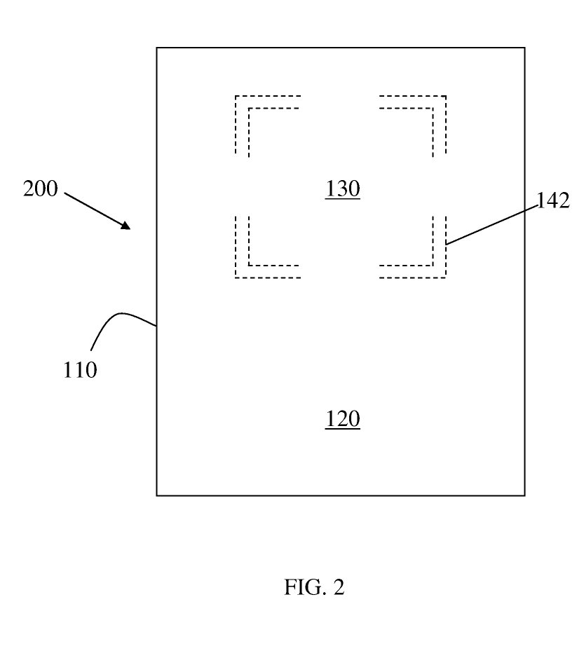

Although indicated as an embossed circle 140, the embossment may in other embodiments be of different shapes. For example, the embossment may be one or more subsections of a circle, one or more subsections of a triangle, one or more subsections of a square, or any other shape that may demarcate or serve as an indication of the location of the working area of the swab or of one or more boundaries of the working area. FIG. 2 illustrates a swab 200 where an embossment 142 is in the form of portions of a square which delineate the borders of a square shaped working area 130.

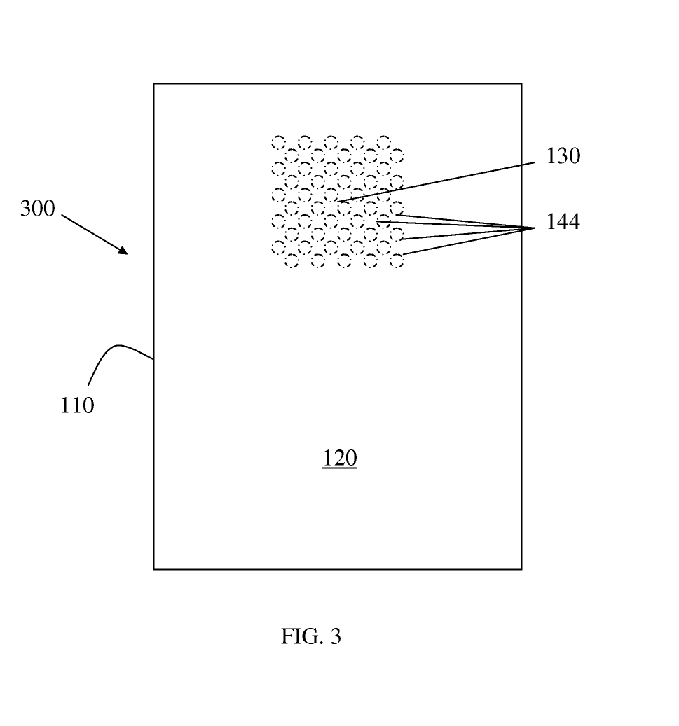

In some embodiments, a pattern of embossment, for example, embossed dots, letters, numbers, or pictures, may be present throughout one or both of the working area 130 and the border portion 120. For example, FIG. 3 illustrates a swab 300 where the working area 130 is indicated by a plurality of embossed dots 144. The embossed dots 144 may comprise raised areas which facilitate transfer of a sample from an object being tested onto the working area 130. In alternate embodiments, the working area 130 and the border portion 120 may be embossed with different patterns.

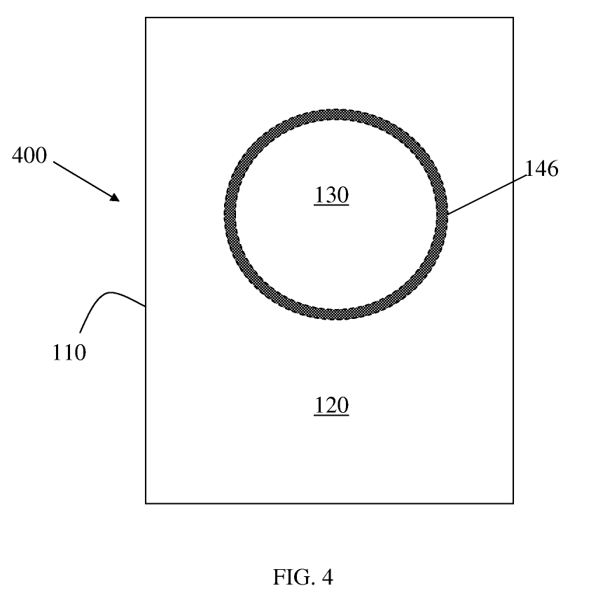

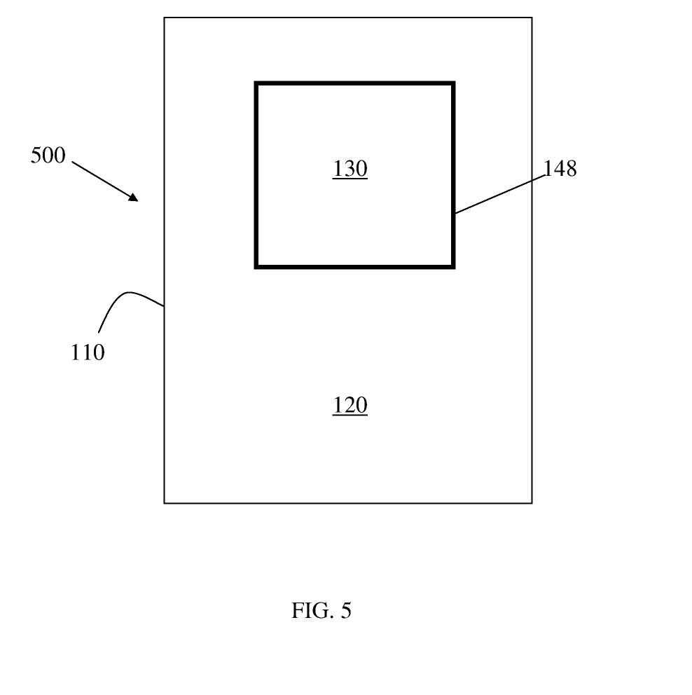

In another embodiment of a swab, indicated at 400 in FIG. 4, an indication of the boundary between the working area 130 and the border portion 120 of the swab 400 is demarcated by a colored circle 146 provided on the substrate 110 about the boundary of the working area 130. The circle may be formed in any manner known in the art, for example, from ink printed on the substrate 110, or by use of a differently colored material to form the circular area 146 than for the rest of the substrate 100. The colored circle 146 may demarcate a boundary of the working area 130 and may provide a visual indication to an operator of which portions of the swab 200 substrate, for example, the portions outside of the colored circle, may be handled and which portions, for example, portions within the colored circle, should not. The colored circle 146 may provide a visual indication of the location of the working area 130 which may facilitate proper collection of a sample within the working area 130 and/or positioning of the swab in an analysis/detection system by an operator. The working area 130 may be demarcated by colored regions of different shapes than the colored circle 146 indicated. For example, a boundary or the working area 130 may be indicated by a colored square 148, as shown for the swab 500 in FIG. 5, a triangle, or any other desired shape or portion thereof.

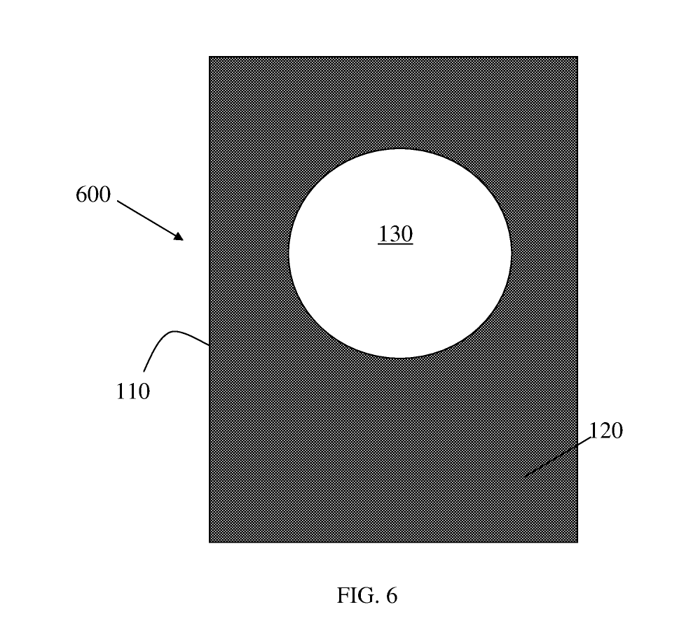

In another embodiment of a swab, indicated at 600 in FIG. 6, the working area 130 and the border portion may be colored differently. For example, as indicated in FIG. 3, the border portion 120 of the swab 300 may be colored darker than the working area 130. In other embodiments, the border portion 120 may be patterned, for example, with lines or dots. The coloring may be produced by any method known in the art, for example, by forming the working area 130 and border portion 120 from different materials, or by coloring the working area 130 or the border portion 120 with ink. In some embodiments the working area 130 may be colored or patterned and the border portion 120 uncolored. In other embodiments, both the working area 130 and the border portion 120 may be colored or patterned, but in different colors and/or patterns so that the working area 130 may be distinguished from the border portion 120.

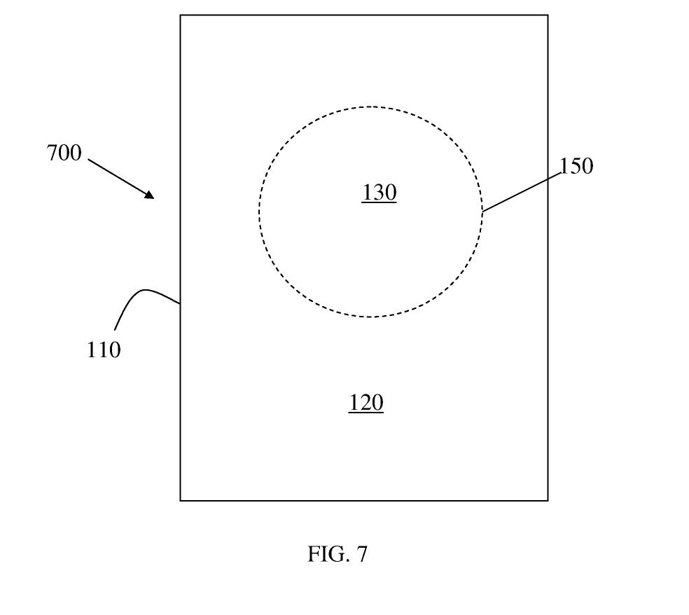

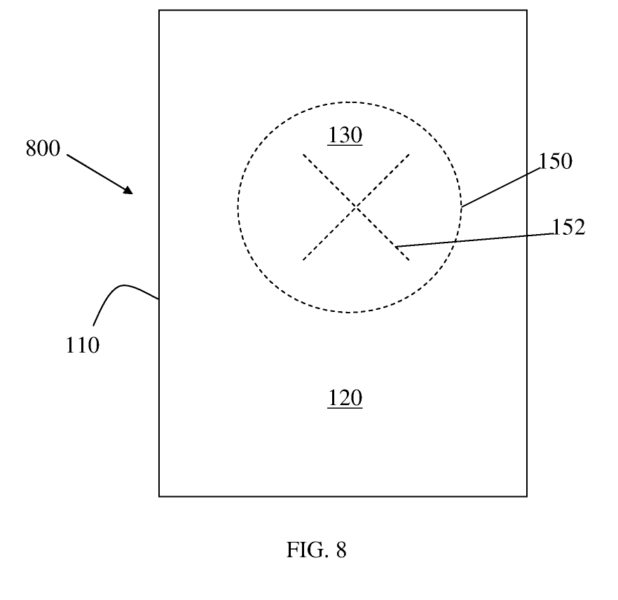

In another embodiment of a swab, indicated at 700 in FIG. 7, the boundary between the working area 130 and the border portion 120 of the swab 400 is marked by providing stitching 150 in the substrate 110 about the boundary of the working area 130. The stitching may be formed of a material that is the same as or different from the material of which the swab substrate is formed. The stitching may be formed of a material that is the same or a different color from the material of which the swab substrate is formed. The stitching may provide a visual indication of the location of the working area, a tactile indication of the location of the working area, or both. The stitching 150 may be provided in the form of a circle as illustrated in FIG. 4, but any other shape useful for indicating the location of the working area 130 may alternatively or additionally be used. In some embodiments, stitching, for example, in the form of an “X” as indicated at 152 in the swab 800 illustrated in FIG. 8 may be used to identify the center of the working area 130 or other regions within the working area. The stitching 152 may be provided in addition to, or as an alternative to the stitching 150.

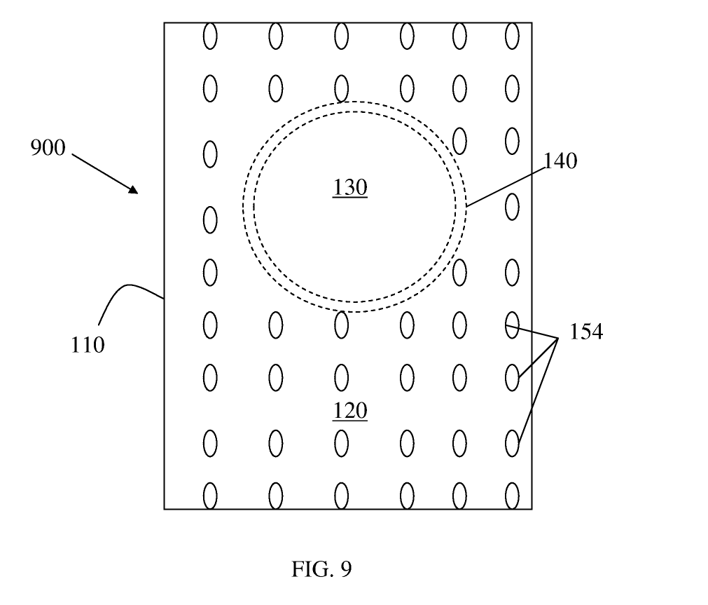

In some embodiments, such as the swab 900 illustrated in FIG. 9, the working area 130 and the border portion 120 may be differentiated by providing a pattern, for example a series of holes 154 in the border portion 120. These holes 154 may be provided in addition to or as an alternative to other indicators of the location of the working area, for example, an embossment 140.

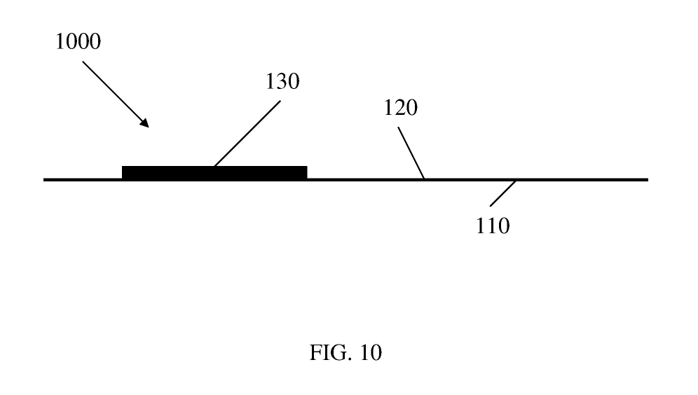

In another embodiment, as illustrated in FIG. 10 in a side view, the working area 130 of a swab 1000 may be raised from the border portion 120. The working area may be raised by, for example, embossing a portion of the substrate 110 to form the working area 130, or by providing a layer of material on the substrate 110, which may be the same as or different from the material of which the substrate is comprised, to form the working area 130. The layer of material may be adhered to the substrate 110 using any known method, for example, by gluing or stitching.

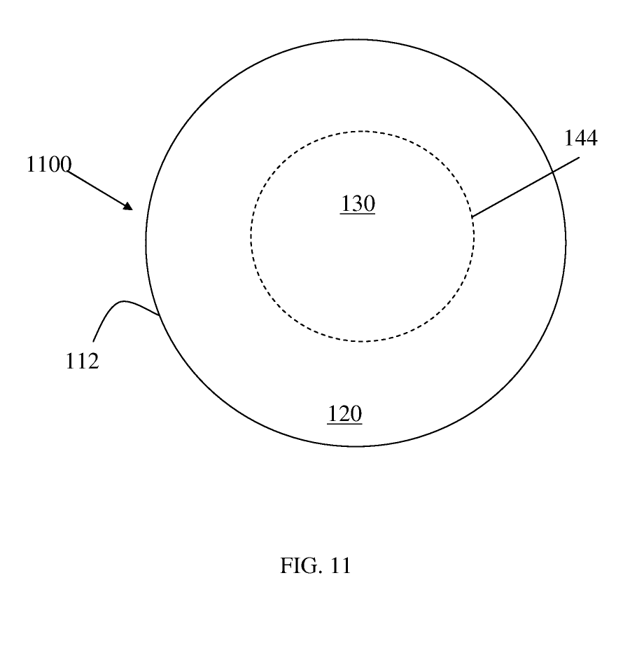

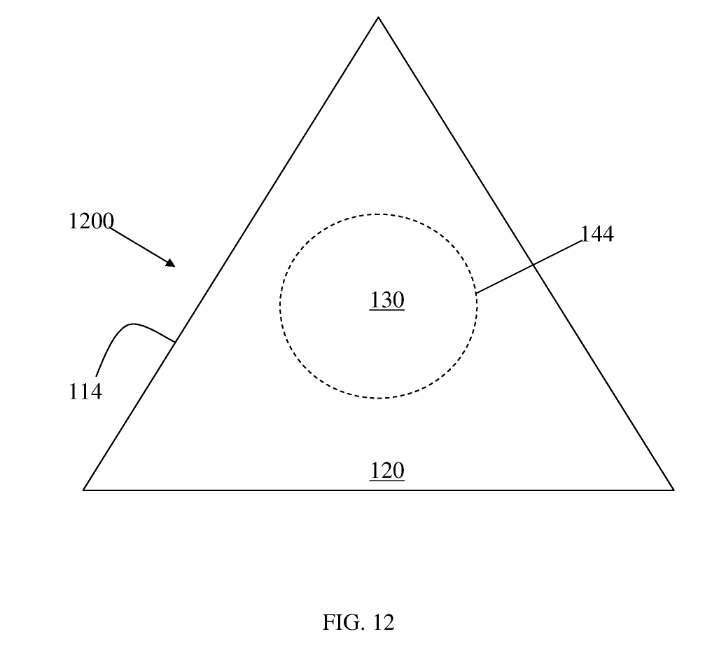

In various embodiments, the swab may be formed from a generally square or rectangular shaped substrate, such as illustrated in FIGS. 1-9, but may also be shaped as an oval or circle, such as swab 1100 illustrated in FIG. 11, or as a triangle, such as swab 1200 illustrated in FIG. 12. The feature demarcating the working area 130 may have a similar shape as the substrate, such as in swab 1100 where both the substrate and the working area indicator, which may comprise stitching 144, are substantially circular. Alternatively, the feature demarcating the working area 130 may have a different shape than the substrate, such as in swab 1200 where the substrate is substantially triangular and the working area indicator, which may comprise stitching 144, is substantially circular.

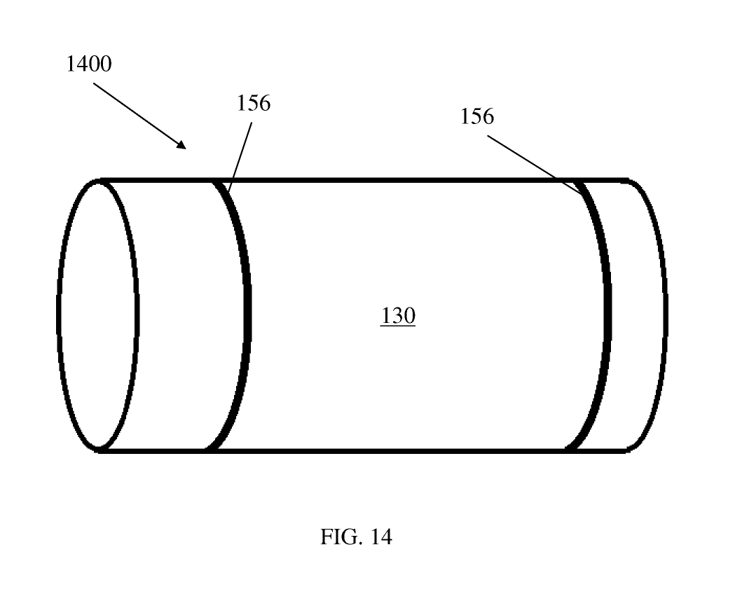

In a further embodiment, the swab may be an Itemiser 3/DX™ trap, available from DSA Detection, North Andover, Mass. or one of the other types of sample traps available from DSA Detection. Some examples of these swabs may have a shape similar to the swab 1400 illustrated in FIG. 14.

In some embodiments, the swab may be formed into a tube, a sock-like construct, a bag-like construct, or other shape as desired to fit properly onto a particular sample testing wand. FIG. 14 illustrates a tubular swab 1400 with a working area 130 demarcated by colored lines 156 extending around the swab at two different locations.

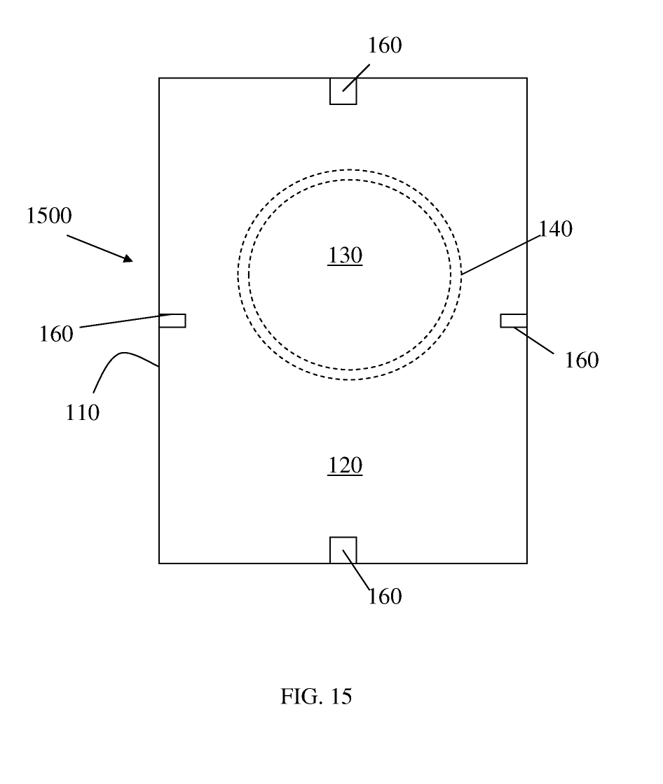

In further embodiments, the demarcation of the working area for use in facilitating aligning the swab on a sample collection apparatus may be different from a second indicator or marking on the swab that facilitates proper alignment of the swab within an analysis/detection system. As illustrated in FIG. 15, a swab 1500 may include an indicator, for example, an embossed circle 140 of a location of a working area 130, and/or may include one or more additional indicators 160 which are used to align the swab in an analysis/detection system. The indicators 160 may be embossments, colored regions, stitching, holes, or any of the other types of indicators described in the various embodiments above for indicating a location of a working area of a swab. The indicators 160 may be shaped as circles, rectangles, triangles, or any other shape desired.

In any of the above embodiments, the indicator of the working area 130, for example, an embossed, colored, or stitched shape, may be formed at a boundary of the working area 130, within the boundary of the working area 130, or outside the boundary of the working area 130.

Having thus described several aspects of at least one embodiment of this invention, it is to be appreciated various alterations, modifications, and improvements will readily occur to those skilled in the art. Any one or more features of any of the embodiments described above may be combined. For example, a swab in accordance with further embodiments of the present invention may include both coloring, such as the colored areas illustrated in FIGS. 4-6 and one or more embossed areas, such as illustrated in FIGS. 1-3 to provide an indication of the location of a working area of the swab. Such alterations, modifications, and improvements are intended to be part of this disclosure, and are intended to be within the spirit and scope of the invention. Accordingly, the foregoing description and drawings are by way of example only.

What is claimed is:

1. A swab for the collection and/or analysis of materials for the presence of a substance comprising:
a substrate including a working area, the working area configured to collect material; and
a marking indicating a portion of the working area.

2. The swab of claim 1, wherein the marking provides a visual indication of a location of the working area.

3. The swab of claim 1, wherein the marking provides a tactile indication of a location of the working area.

4. The swab of claim 1, wherein the marking comprises an embossment in the substrate.

5. The swab of claim 2, wherein the marking comprises a colored area of the substrate.

6. The swab of claim 2, wherein the marking comprises a stitching in the substrate.

7. The swab of claim 1, further comprising a marking indicating a proper position of the swab within a sample analysis system.

8. A method for testing an article for the presence of a substance comprising:
providing a swab having an indicated working area, the indication of the working area facilitating placement of the swab in a sample collection apparatus.

9. The method of claim 8, wherein providing the swab comprises visually indicating the working area.

10. The method of claim 8, wherein providing the swab comprises providing a tactile indication of the working area.

11. The method of claim 8 wherein providing the swab comprises indicating the working area by embossing a portion of the swab.

12. The method of claim 9, wherein visually indicating the working area comprises coloring a portion of the swab.

13. The method of claim 9, wherein visually indicating the working area comprises providing a stitching in a portion of the swab.

14. The method of claim 8, wherein providing the swab further comprises forming a marking in the swab indicating a position of the swab within a sample analysis system.

15. The method of claim 8, wherein the indication of the working area facilitates placement of the swab in a sample collection apparatus such that the working area is substantially centered in a sample collection area of the sample collection apparatus.

16. A method of forming a swab comprising:
providing a substrate;
defining a working area on the substrate; and
indicating a portion of the working area on the substrate.

17. The method of claim 16, wherein indicating the portion of the working area comprises embossing a portion of the substrate.

18. The method of claim 17, wherein embossing a portion of the swab comprises embossing the working area.

19. The method of claim 16, wherein indicating the portion of the working area comprises coloring a portion of the substrate.

20. The method of claim 16, wherein indicating the portion of the working area comprises including stitching having a different color than the substrate in a portion of the substrate.

21. The method of claim 16, further comprising forming an indicator on the swab which facilitates the positioning of the swab in a sample analysis system.
